(19) United States
(12) Patent Application Publication
(10) Pub. No.: US 2016/0352816 A1
(43) Pub. Date: Dec. 1, 2016

(54) Method and system for sharing data between social networking platforms

(71) Applicant: Tencent Technology (Shenzhen) Company Limited, Shenzhen (CN)

(72) Inventor: Siyu Xiao, Shenzhen (CN)

(21) Appl. No.: 15/225,825

(22) Filed: Aug. 2, 2016

Related U.S. Application Data
(63) Continuation of application No. PCT/CN2014/088699, filed on Oct. 16, 2014.

(30) Foreign Application Priority Data
Feb. 26, 2014 (CN) 201410067157.6

(51) Int. Cl. H04L 29/08; H04L 12/58; H04M 1/2745; H04W 4/20

(52) U.S. Cl. CPC H04L 67/10; H04W 4/206; H04L 51/32; H04L 67/02; H04M 1/274516; H04W 88/02

(57) ABSTRACT

A method and system for sharing data (e.g., name-cards) between social networking platforms are disclosed. A server corresponding to a first social networking platform includes processor(s) and memory. The server receives a name-card sharing request from a sender in the first social networking platform to send a name-card corresponding to the sender. In accordance with the name-card sharing request, the server identifies one or more recipients for the name-card in a second social networking platform distinct from the first social networking platform. The server sends to the second social networking platform the name-card corresponding to the sender and recipient information for the one or more identified recipients in the second social networking platform, where the name-card is displayed to the one or more identified recipients in the second social networking platform, and where the displayed name-card includes textual information identifying the sender and the first social networking platform.

### CROSS REFERENCE TO RELATED APPLICATIONS

This is a continuation application of International Patent Application No.: PCT/CN2014/088699, filed on Oct. 16, 2014, which claims priority to Chinese Patent Application No. 201410067157.6, entitled “METHOD, APPARATUS, CLIENT TERMINAL AND SERVER FOR INFORMATION SHARING”, filed on Feb. 26, 2014, which is incorporated by reference in its entirety.

### FIELD OF THE TECHNOLOGY

The present disclosure relates to the field of Internet technologies, and in particular, to a method and system for sharing data (e.g., name-cards) between social networking platforms.

### BACKGROUND OF THE TECHNOLOGY

With the development of Internet technologies, there are an increasing number of kinds of social networking applications that provide social services to users. When users uses multiple social application clients, the users may wish to share their business cards in a social application client of a first type to a social application client of a second type, so that a friend of the user using the social application of the second type may view the business card shared by the user, and contact the user according to the business card. The existing sharing method is cumbersome and inconvenient in that it only allows a user to share a code encoding a link, and the recipient has to use special software (e.g., a QR code scanner) to decode the link and then follow the link to view the information about the sender. The utilization rate of such sharing method is low, and user experience is poor.

### SUMMARY

In some embodiments, a method of sharing data (e.g., name-cards) between social networking platforms at a server (e.g., server system 108, FIGS. 1-2) with one or more processors and memory, where the server is associated with a first social networking platform. The method includes receiving a name-card sharing request from a sender in the first social networking platform to send a name-card corresponding to the sender. In accordance with the name-card sharing request, the method includes identifying one or more recipients for the name-card in a second social networking platform distinct from the first social networking platform. The method includes sending to the second social networking platform the name-card corresponding to the sender and recipient information for the one or more identified recipients in the second social networking platform, where the name-card is displayed to the one or more identified recipients in the second social networking platform, and where the displayed name-card includes textual information identifying the sender and the first social networking platform.

In some embodiments, a computer system (e.g., server system 108 (FIGS. 1-2), client device 104 (FIGS. 1 and 3), or a combination thereof) includes one or more processors and memory storing one or more programs for execution by the one or more processors, the one or more programs include instructions for performing, or controlling performance of, the operations of any of the methods described herein. In some embodiments, a non-transitory computer readable storage medium storing one or more programs, the one or more programs comprising instructions, which, when executed by a computer system (e.g., server system 108 (FIGS. 1-2), client device 104 (FIGS. 1 and 3), or a combination thereof) with one or more processors, cause the computer system to perform, or control performance of, the operations of any of the methods described herein. In some embodiments, a computer system (e.g., server system 108 (FIGS. 1-2), client device 104 (FIGS. 1 and 3), or a combination thereof) includes means for performing, or controlling performance of, the operations of any of the methods described herein.

Various advantages of the present application are apparent in light of the descriptions below.

### BRIEF DESCRIPTION OF THE DRAWINGS

The aforementioned features and advantages of the disclosed technology as well as additional features and advantages thereof will be more clearly understood hereinafter as a result of a detailed description of preferred embodiments when taken in conjunction with the drawings.

To describe the technical solutions in the embodiments of the present disclosed technology or in the prior art more clearly, the following briefly introduces the accompanying drawings required for describing the embodiments or the prior art. Apparently, the accompanying drawings in the following description show merely some embodiments of the present disclosed technology, and persons of ordinary skill in the art may still derive other drawings from these accompanying drawings without creative efforts.

FIG. 1 is a block diagram of a server-client environment in accordance with some embodiments.

FIG. 2 is a block diagram of a server system in accordance with some embodiments.

FIG. 3 is a block diagram of a client device in accordance with some embodiments.

FIG. 4 is a block diagram of a respective other social networking platform in accordance with some embodiments.

FIGS. 5A-5C illustrate exemplary user interfaces for sharing data between social networking platforms in accordance with some embodiments.

FIG. 6 illustrates a flow diagram of a process for sharing data between two or more social networking platforms in accordance with some embodiments.

FIGS. 7A-7B illustrate a flow diagram of a process for sharing data between two or more social networking platforms in accordance with some embodiments.

FIGS. 8A-8D illustrate a flowchart diagram of a method of sharing name-cards between social networking platforms in accordance with some embodiments.

FIG. 9 is a block diagram of a first server for sharing data in accordance with some embodiments.

FIG. 10 is a block diagram of a first social networking platform application for sharing data in accordance with some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The following clearly and completely describes the technical solutions in the embodiments of the present application with reference to the accompanying drawings in the embodiments of the present application. Apparently, the described embodiments are merely a part rather than all of the embodiments of the present application. All other embodiments obtained by persons of ordinary skill in the art based on the embodiments of the present application without creative efforts shall fall within the protection scope of the present application.

As a background, currently, a common business card sharing method includes: A current user sends a business card sharing request to a first server by using a first-type social application client. After receiving the business card sharing request, the first server acquires a two-dimensional code business card of a first user account of the current user in the first-type social application and shares the acquired two-dimensional code business card to a second server corresponding to a second-type social application client. When the second-type social application client accesses the second server, the second server shares the two-dimensional code business card to the second-type social application client, and presents the two-dimensional code business card in the second-type social application client in a two-dimensional code form. The second-type social application client refers to a social application client used by a friend of the current user in the second-type social application.

The above sharing method has the following problem(s): The two-dimensional code business card is presented in the second-type social application client in a two-dimensional code form, and a friend needs to scan the two-dimensional code to acquire content in the two-dimensional code instead of visually acquiring needed information from the two-dimensional code. Therefore, in a practical application, the friend does not pay attention to the two-dimensional code presented in the second-type social application client, resulting in a low utilization rate for shared business card using the foregoing business card sharing method. Also, the server uses resources to share the business card, thereby wasting the resources of the server. The present disclosure presents an improved technique for sharing name-card information across multiple social network platforms, where the name card information is plainly visible to the recipient on a second social network platform even though the sender of the name card composes and sends the name card from a first social network platform distinct from the second social network platform.

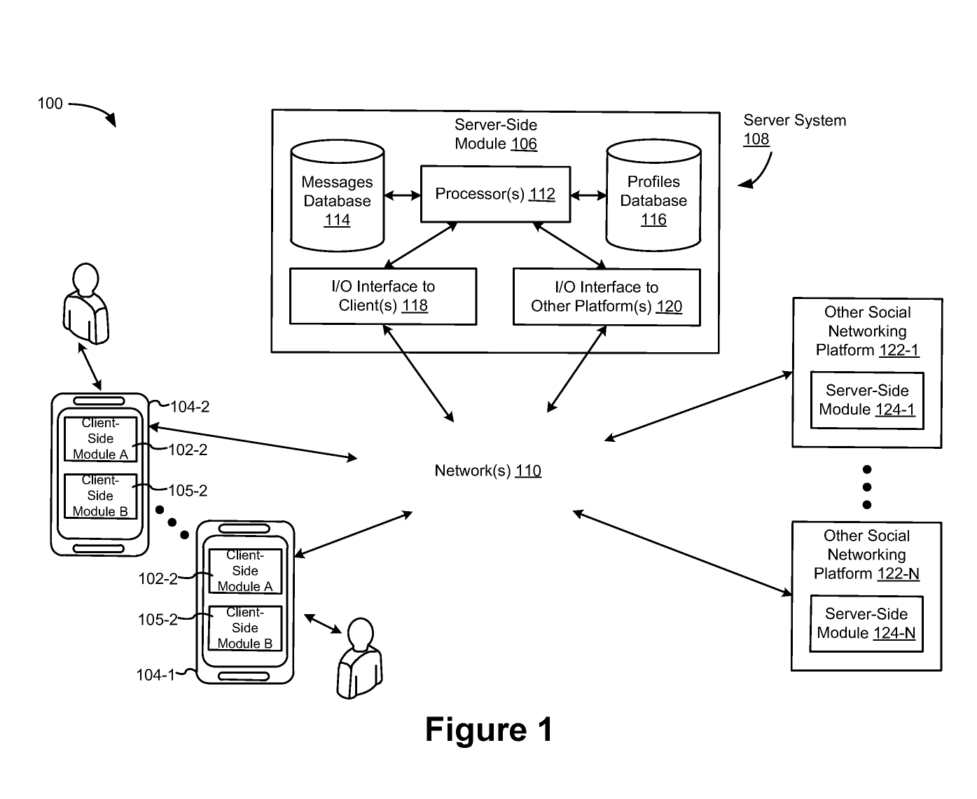

As shown in FIG. 1, data processing for a first social networking platform is implemented in a server-client environment 100 in accordance with some embodiments. In accordance with some embodiments, data processing for the first social networking platform includes client-side processing 102-1, 102-2 (hereinafter “client-side modules 102”) executed on a client device 104-1, 104-2, and server-side processing 106 (hereinafter “server-side module 106”) executed on a server system 108. Client-side module 102 communicates with server-side module 106 through one or more networks 110. Client-side module 102 provides client-side functionalities for the first social networking platform and communications with server-side module 106. Server-side module 106 provides server-side functionalities for the first social networking platform (e.g., communications, payment processing, user authentication, etc.) for any number of client modules 102 each residing on a respective client device 104.

In some embodiments, server-side module 106 includes one or more processors 112, messages database 114, profiles database 116, an I/O interface to one or more clients 118, and an I/O interface to the other platform(s) 120. I/O interface to one or more clients 118 facilitates the client-facing input and output processing for server-side module 106. In some embodiments, one or more processors 112 process and respond to name-card sharing requests from client devices 104. Messages database 114 stores messages sent by users in the first social networking platform. Profiles database 116 stores a user profile for each user associated with the first social networking platform. I/O interface to one or more other platform(s) 120 facilitates communications with one or more other social networking platforms 122.

In FIG. 1, data processing for one or more other social networking platforms 122 is implemented in server-client environment 100 in accordance with some embodiments. In accordance with some embodiments, data processing for a respective one of the other social networking platform(s) 122 (i.e., a second social networking platform) includes client-side processing 105-1, 105-2 (hereinafter “client-side modules 105”) executed on a client device 104-1, 104-2, and server-side processing 124 (hereinafter “server-side module 124”) executed on the respective one of the other social networking platform(s) 122. Client-side module 105 communicates with server-side module 124 through one or more networks 110. Client-side module 105 provides client-side functionalities for the respective one of the other social networking platform(s) 122 and communications with server-side module 124. Server-side module 124 provides server-side functionalities for the respective one of the other social networking platform(s) 122 (e.g., communications, user authentication, etc.) for any number of client modules 105 each residing on a respective client device 104.

Examples of client device 104 include, but are not limited to, a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices.

Examples of one or more networks 110 include local area networks (LAN) and wide area networks (WAN) such as the Internet. One or more networks 110 are, optionally, implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some embodiments, server system 108 is implemented on one or more standalone data processing apparatuses or a distributed network of computers. In some embodiments, server system 108 also employs various virtual devices and/or services of third party service providers (e.g., third-party cloud service providers) to provide the underlying computing resources and/or infrastructure resources of server system 108.

In some embodiments, the first social networking platform, as shown in FIG. 1, includes both a client-side portion (e.g., client-side module 102) and a server-side portion (e.g., server-side module 106). In some embodiments, data processing for the first social networking platform is implemented as a standalone application installed on client device 104. In addition, the division of functionalities between the client and server portions for the first social networking platform can vary in different embodiments. For example, in some embodiments, client-side module 102 is a thin-client that provides only user-facing input and output processing functions, and delegates all other data processing functionalities for the first social networking platform to a backend server (e.g., server system 108).

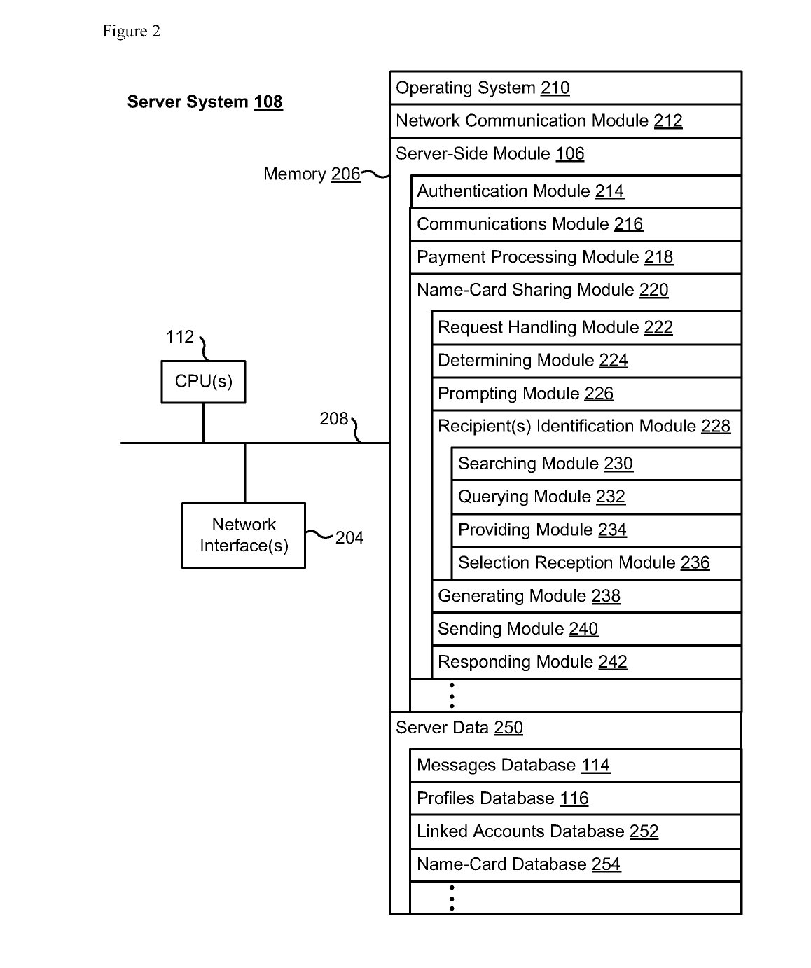

FIG. 2 is a block diagram illustrating server system 108 for a first social networking platform in accordance with some embodiments. Server system 108, typically, includes one or more processing units (CPUs) 112, one or more network interfaces 204 (e.g., including I/O interface to one or more clients 118 and I/O interface to generation service 120), memory 206, and one or more communication buses 208 for interconnecting these components (sometimes called a chipset). Memory 206 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 206, optionally, includes one or more storage devices remotely located from one or more processing units 112. Memory 206, or alternatively the non-volatile memory within memory 206, includes a non-transitory computer readable storage medium. In some implementations, memory 206, or the non-transitory computer readable storage medium of memory 206, stores the following programs, modules, and data structures, or a subset or superset thereof:
operating system 210 including procedures for handling various basic system services and for performing hardware dependent tasks;
network communication module 212 for connecting server system 108 to other computing devices (e.g., client devices 104 and other social networking platform(s) 122) connected to one or more networks 110 via one or more network interfaces 204 (wired or wireless);
server-side module 106, which provides server-side data processing for a first social networking platform (e.g., communications, payment processing, etc.), includes, but is not limited to:
   authentication module 214 for authenticating users associated with client devices 104 to use the first social networking platform;
   communications module 216 for managing and routing messages sent between users of the first social networking platform;
   (optionally) payment processing module 214 for processing transactions for a respective user of the first social networking platform based on payment data in a user profile in profiles database 116 corresponding to the respective user; and
   name-card sharing module 220 for sharing a name-card for a first user in the first social networking platform to one or more recipients in at least one of other social networking platforms 122, including but not limited to:
      request handling module 222 for receiving and processing name-card sharing requests from client devices 104;
      determining module 224 for determining whether a first user account in the first social networking platform corresponding to a respective name-card sharing request is linked to a second user account in a second social networking platform based on linked accounts database 252;
      prompting module 226 for prompting the user of the first user account corresponding to the respective name-card sharing request to provide authentication information for the second social networking platform in accordance with a determination that the first user account is not linked to second user account in the second social networking platform;
      recipient(s) identification module 228 for identifying one or more recipients in at least one of other social networking platforms 122 based on the respective name-card sharing request, including but not limited to:
         searching module 230 for performing a search query against a first database of users in the first social networking platform and a second database of users in the second social networking platform;
         querying module 232 for querying the second social networking platform to obtain a list of contacts for the second user account in the second social networking platform that is linked to the first user account in the first social networking platform;
         providing module 234 for providing search results and/or the list of contacts to client device 104 that sent the respective name-card sharing request; and
         selection reception module 236 for receiving a recipient selection message from the client device 104 selecting one or more recipients from the provided search results and/or list of contacts;
      generating module 238 for generating the name-card;
      sending module 240 for sending the name-card corresponding to the user of client device 104 that sent the respective name-card sharing request along with recipient information for the one or more identified recipients in the second social networking platform; and
      responding module 242 for responding to login and/or registration requests; and
server data 250 storing data for the first social networking platform, including but not limited to:
   messages database 114 storing messages sent by users in the first social networking platform;
   profiles database 116 storing user profiles for users of the first social networking platform, where a respective user profile for a user includes a user identifier (e.g., an account name or handle), login credentials to the first social networking platform, (optionally) payment data (e.g., linked credit card information, app credit or gift card balance, billing address, shipping address, etc.), an IP address or preferred contact information, contacts list, custom parameters for the user (e.g., age, location, hobbies, etc.), and identified trends and/or likes/dislikes of the user;
   linked accounts database 252 storing login credentials for user accounts in other social networking platforms 122 that are linked to user accounts in the first social networking platform; and
   name-card database 254 storing user information and/or generated name-cards for user accounts in the first social networking platform.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, memory 206, optionally, stores a subset of the modules and data structures identified above. Furthermore, memory 206, optionally, stores additional modules and data structures not described above.

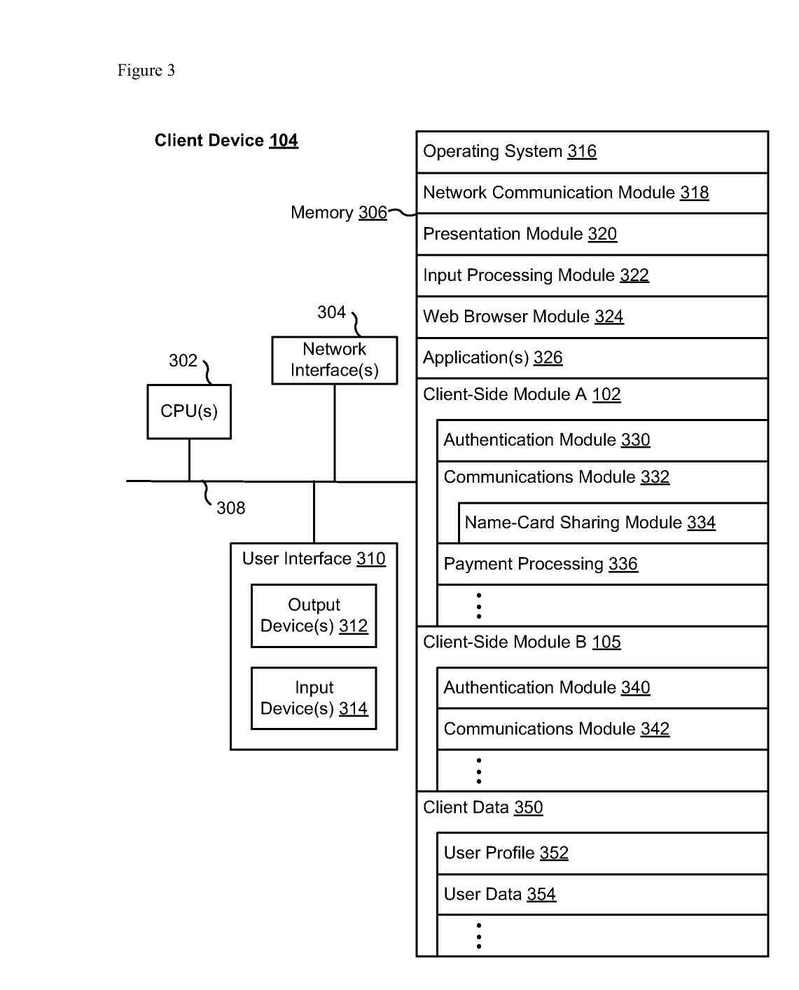

FIG. 3 is a block diagram illustrating a representative client device 104 associated with a user in accordance with some embodiments. Client device 104, typically, includes one or more processing units (CPUs) 302, one or more network interfaces 304, memory 306, and one or more communication buses 308 for interconnecting these components (sometimes called a chipset). Client device 104 also includes a user interface 310. User interface 310 includes one or more output devices 312 that enable presentation of media content, including one or more speakers and/or one or more visual displays. User interface 310 also includes one or more input devices 314, including user interface components that facilitate user input such as a keyboard, a mouse, a voice-command input unit or microphone, a touch screen display, a touch-sensitive input pad, a camera, a gesture capturing camera, or other input buttons or controls. Furthermore, some client devices 104 use a microphone and voice recognition or a camera and gesture recognition to supplement or replace the keyboard. Memory 306 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 306, optionally, includes one or more storage devices remotely located from one or more processing units 302. Memory 306, or alternatively the non-volatile memory within memory 306, includes a non-transitory computer readable storage medium. In some implementations, memory 306, or the non-transitory computer readable storage medium of memory 306, stores the following programs, modules, and data structures, or a subset or superset thereof:
operating system 316 including procedures for handling various basic system services and for performing hardware dependent tasks;
network communication module 318 for connecting client device 104 to other computing devices (e.g., server system 108 and other social networking platform(s) 122) connected to one or more networks 110 via one or more network interfaces 304 (wired or wireless);
presentation module 320 for enabling presentation of information (e.g., a user interface for a respective social networking platform, widget, websites or web pages thereof, game, and/or application, audio and/or video content, text, etc.) at client device 104 via one or more output devices 312 (e.g., displays, speakers, etc.) associated with user interface 310;
input processing module 322 for detecting one or more user inputs or interactions from one of the one or more input devices 314 and interpreting the detected input or interaction;
web browser module 324 for navigating, requesting (e.g., via HTTP), and displaying websites and web pages thereof;
one or more applications 326 for execution by client device 104 (e.g., games, application marketplaces, payment platforms, and/or other web or non-web based applications);
client-side module A 102, which provides client-side data processing and functionalities for the first social networking platform provided by server system 108, including but not limited to:
   authentication module 330 for authenticating the user of client device 104 to access his/her account in the first social networking platform;
   communications module 332 for sending messages to and receiving messages from other users of the first social networking platform (e.g., instant messaging, group chat, message board, message/news feed, and the like), including but not limited to:
      name-card sharing module 334 for sharing the user's name-card with one or more recipients in at least one of other social networking platforms 122; and
   (optionally) payment processing 334 for processing payments associated with transactions initiated within the first social networking platform or at a merchant's website within web browser module 324;
client-side module B 105, which provides client-side data processing and functionalities for a respective one of the other social networking platforms 122 (i.e., the second social networking platform), including but not limited to:
   authentication module 340 for authenticating the user of client device 104 to access his/her account in the respective one of the other social networking platforms 122; and
   communications module 342 for sending messages to and receiving messages from other users of the respective one of the other social networking platforms 122 (e.g., instant messaging, group chat, message board, message/news feed, and the like); and
client data 350 storing data associated with the first social networking platform and the respective one of the other social networking platforms 122, including but not limited to:
   user profile 352 storing a user profile associated with the user of client device 104 for each of the first social networking platform and the respective one of the other social networking platforms 122, including a user identifier (e.g., an account name or handle), login credentials to the social networking platform, (optionally) payment data (e.g., linked credit card information, app credit or gift card balance, billing address, shipping address, etc.), an IP address or preferred contact information, contacts list, custom parameters for the user (e.g., age, location, hobbies, etc.), and identified trends and/or likes/dislikes of the user; and
   user data 344 storing data authored, saved, liked, or chosen as favorites by the user of client device 104 in the first social networking platform and the respective one of the other social networking platforms 122.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 306, optionally, stores a subset of the modules and data structures identified above. Furthermore, memory 306, optionally, stores additional modules and data structures not described above.

In some embodiments, at least some of the functions of server system 108 are performed by client device 104, and the corresponding sub-modules of these functions may be located within client device 104 rather than server system 108. In some embodiments, at least some of the functions of client device 104 are performed by server system 108, and the corresponding sub-modules of these functions may be located within server system 108 rather than client device 104. Client device 104 and server system 108 shown in FIGS. 2-3, respectively, are merely illustrative, and different configurations of the modules for implementing the functions described herein are possible in various embodiments.

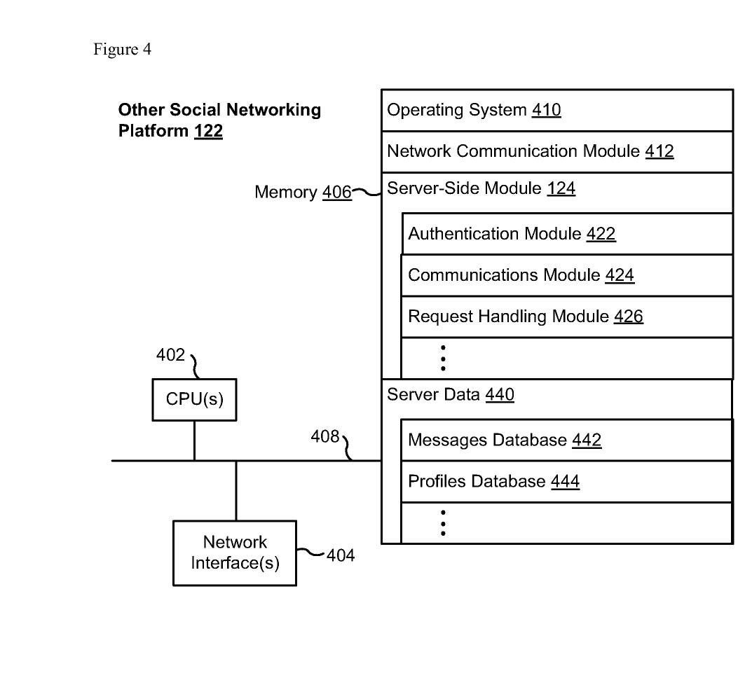

FIG. 4 is a block diagram a respective one of the other social networking platform(s) 122 in accordance with some embodiments. The respective one of the other social networking platform(s) 122, typically, includes one or more processing units (CPUs) 402, one or more network interfaces 404, memory 406, and one or more communication buses 408 for interconnecting these components (sometimes called a chipset). Memory 406 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 406, optionally, includes one or more storage devices remotely located from one or more processing units 402. Memory 406, or alternatively the non-volatile memory within memory 406, includes a non-transitory computer readable storage medium. In some implementations, memory 406, or the non-transitory computer readable storage medium of memory 406, stores the following programs, modules, and data structures, or a subset or superset thereof:
operating system 410 including procedures for handling various basic system services and for performing hardware dependent tasks;
network communication module 412 for the respective one of the other social networking platform(s) 122 to other computing devices (e.g., client devices 104 and server system 108) connected to one or more networks 110 via one or more network interfaces 404 (wired or wireless);
server-side module 124, which provides server-side data processing for the respective one of the other social networking platform(s) 122, includes, but is not limited to:
   authentication module 422 for authenticating users associated with client devices 104 to use the respective one of the other social networking platform(s) 122;
   communications module 424 for managing and routing messages sent between users of the respective one of the other social networking platform(s) 122; and
   request handling module 426 for responding to queries from server system 108; and
data 440 storing data for the respective one of the other social networking platform(s) 122, including but not limited to:
   messages database 442 storing messages sent by users in the respective one of the other social networking platform(s) 122; and
   profiles database 444 storing user profiles for users of the respective one of the other social networking platform(s) 122, where a respective user profile for a user includes a user identifier (e.g., an account name or handle), login credentials to the respective one of the other social networking platform(s) 122, an IP address or preferred contact information, contacts list, custom parameters for the user (e.g., age, location, hobbies, etc.), and identified trends and/or likes/dislikes of the user;
   124.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, memory 406, optionally, stores a subset of the modules and data structures identified above. Furthermore, memory 406, optionally, stores additional modules and data structures not described above.

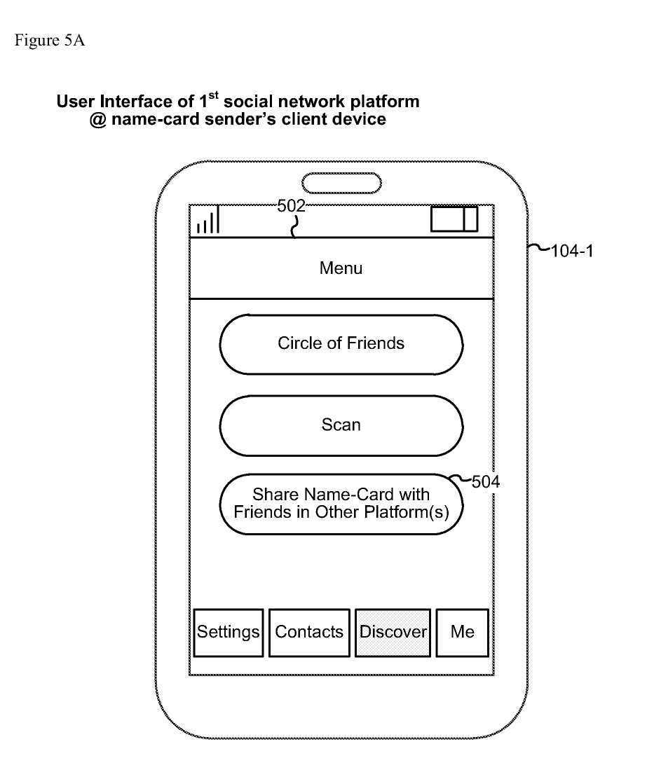

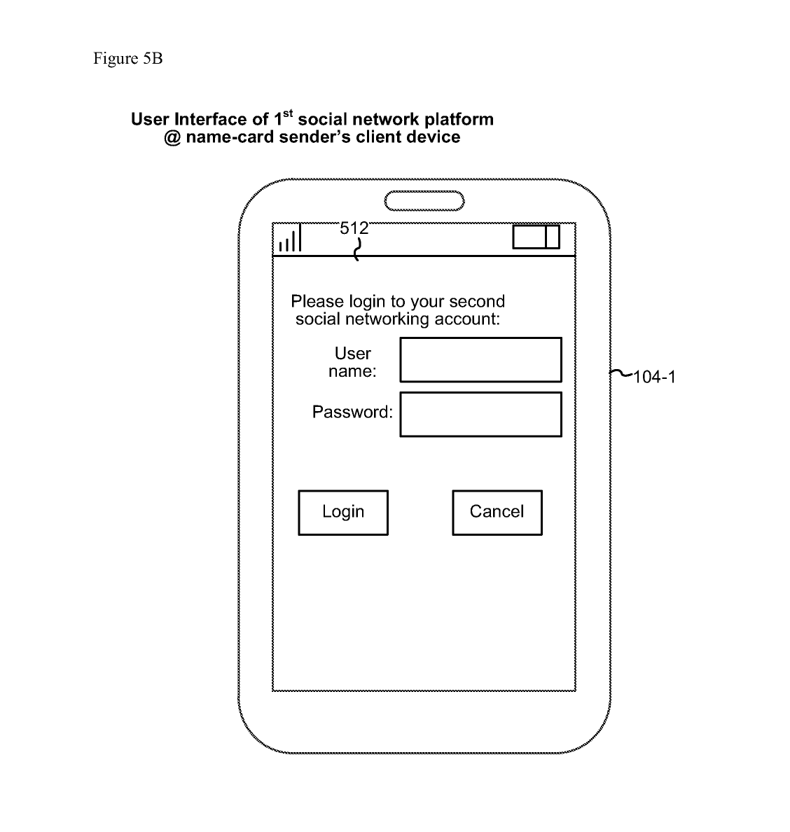

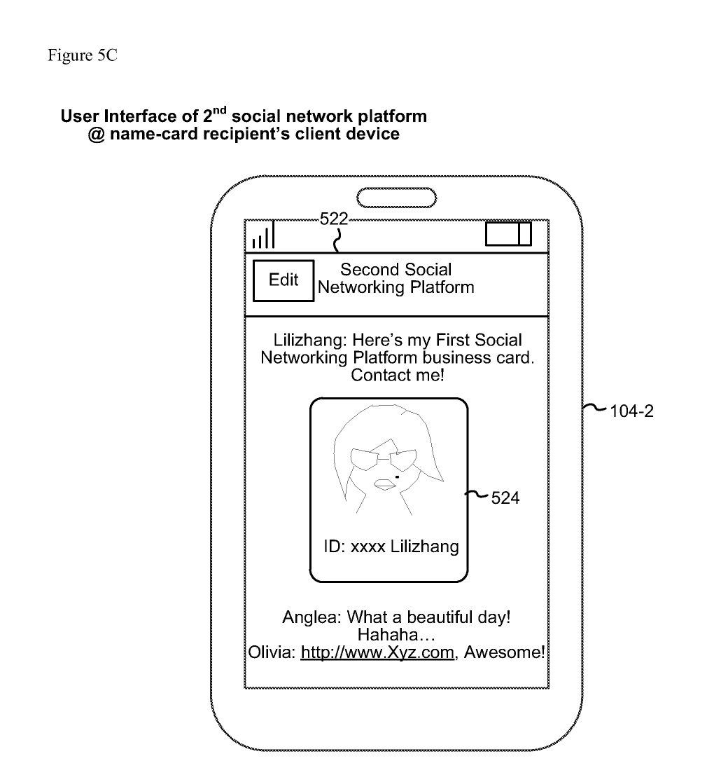

Attention is now directed towards embodiments of user interfaces and associated processes that may be implemented on a client device 104 with a touch screen (sometimes also herein called a “touch screen display”) enabled to receive one or more touch inputs and display information (e.g., media content, websites and web pages thereof, and/or user interfaces for an application such as a web browser and the first and second social networking platform applications). FIGS. 5A-5C illustrate exemplary user interfaces for sharing data (e.g., name-cards) between social networking platforms in accordance with some embodiments.

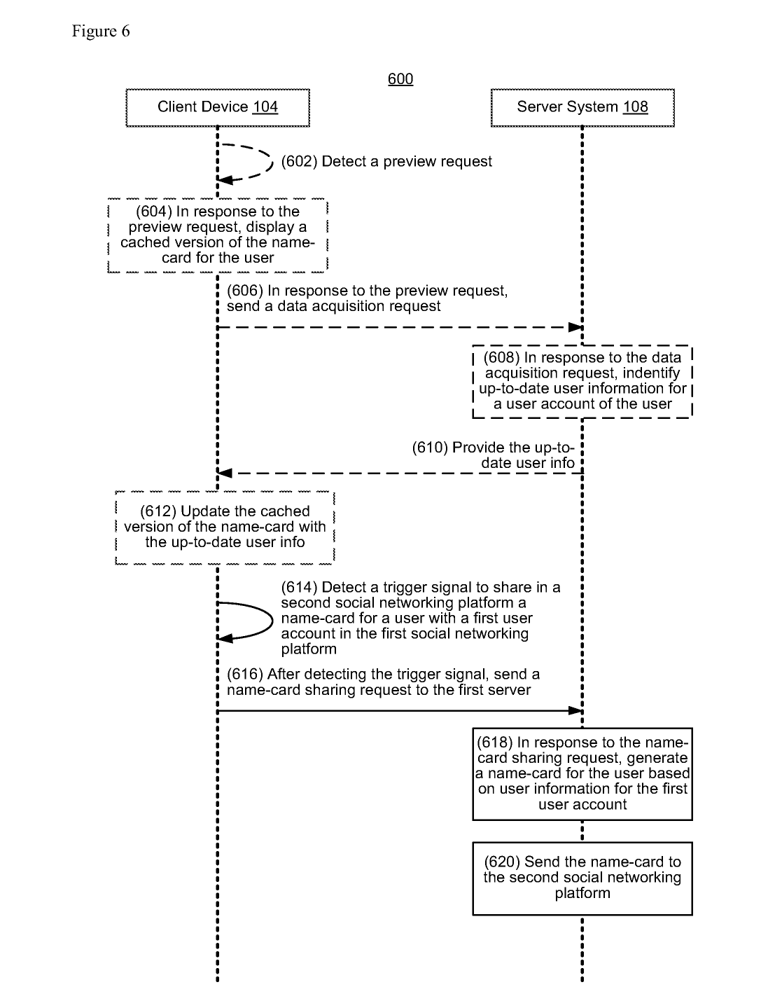

FIGS. 5A-5B show a user interface displayed on a client device 104-1 (e.g., a mobile phone) executing the first social networking platform application (e.g., client-side module A 102, FIGS. 1 and 3); however, one skilled in the art will appreciate that the user interfaces shown in FIGS. 5A-5B may be implemented on other similar computing devices. FIG. 5C shows a user interface displayed on a client device 104-2 (e.g., a mobile phone) executing the second social networking platform application (e.g., client-side module B 105, FIGS. 1 and 3); however, one skilled in the art will appreciate that the user interfaces shown in FIG. 5C may be implemented on other similar computing devices. The user interfaces in FIGS. 5A-5C are used to illustrate the processes and methods described in FIGS. 6, 7A-7B, and 8A-8D.

FIG. 5A illustrates client device 104-1 displaying a menu interface 502 of the first social networking platform application. In FIG. 5A, menu interface 502 includes affordance 504 for sharing the user's name-card with users in other social networking platform. For example, client device 104-1 detects a contact (e.g., touch input provided by a finger or stylus) at a location corresponding to affordance 504. Continuing with this example, in response to detecting the contact, client device 104-1 displays an interface for selecting recipients of the name-card and sends a name-card sharing request to server system 108 corresponding to the first social networking platform to share a name-card for the user of client device 104-1 in a second social networking platform.

For example, in accordance with a determination that the first user account in the first social networking platform of the user of client device 104-1 is not linked to a second user account in the second social networking, server system 108 sends a request to client device 104-1 prompting the user of client device 104-1 to enter authentication information corresponding to the user's account in the second social networking platform. FIG. 5B illustrates client device 104-1 displaying authentication information request interface 512 for entering the user's login credentials for the second social networking platform. In FIG. 5B, authentication information request interface 512 includes a user name field and a password field into which the user of client device 104-1 is able to enter his/her login credentials for the second social networking platform via a virtual keyboard or aurally.

FIG. 5C illustrates client device 104-2 displaying chat interface 522 of the second social networking platform (e.g., an instant messaging application). In FIG. 5C, chat interface 522 corresponds to a group chat between the user of client device 104-2 (i.e., Anglea) and her two friends (i.e., Lilizhang and Olivia). In FIG. 5C, chat interface 522 includes name-card 524 shared by Lilizhang from the first social networking platform to the second social networking platform. In FIG. 5C, name-card 524 includes the ID number for Lilizhang's account in the first social networking platform (i.e., xxxx) and Lilizhang's avatar in the first social networking platform. For example, Angelea or Olivia are able to select Lilizhang's name-card from within the second social networking platform to view Lilizhang's profile in the first social networking platform, register an account in the first networking platform, and/or add Lilizhang as a friend in the first social networking platform.

FIG. 6 illustrates a flow diagram of a process 600 for sharing data between two or more social networking platforms in accordance with some embodiments. In some embodiments, process 600 is performed at least in part by first social networking platform application executed on a client device with one or more processors and memory and a server with one or more processors and memory that manages and operations the first social networking platform. For example, in some embodiments, process 600 is performed at least in part by client device 104 (FIGS. 1 and 3) or a component thereof (e.g., client-side module A 102, FIGS. 1 and 3) and at least in part by a server system 108 (FIGS. 1-2) or a component thereof (e.g., server-side module 106, FIG. 2). Optional operations are indicated by dashed lines (e.g., boxes with dashed-line borders).

In some embodiments, data processing for a first social networking platform is implemented in client-server environment 100 (FIG. 1) with a server system 108 and client-side module A 102 (i.e., the first social networking platform application) executed on one or more client devices 104. In some embodiments, server system 108 (FIGS. 1-2) manages and operates the first social networking platform. For example, the first social networking platform is an IM (Instant Messenger) application, an SNS (Social Networking Services) application, or the like, or a combination thereof. In some embodiments, a respective client-side module A 102 (FIGS. 1 and 3) is associated with a user account in the first social networking platform that corresponds to a user of client device 104 (FIGS. 1 and 3).

In some embodiments, data processing for a second social networking platform is implemented in client-server environment 100 (FIG. 1) with a respective one of social networking platform(s) 122 and client-side module B 105 (i.e., a second social networking platform application) executed on one or more client devices 104. In some embodiments, the respective one of social networking platform(s) 122 (FIGS. 1 and 4) manages and operates the second social networking platform. For example, the second social networking platform is an IM (Instant Messenger) application, an SNS (Social Networking Services) application, or the like, or a combination thereof. In some embodiments, a respective client-side module B 105 (FIGS. 1 and 3) is associated with a user account in the second social networking platform that corresponds to a user of client device 104 (FIGS. 1 and 3).

In some embodiments, the client device detects (602) a preview request. For example, the user of client device 104 selects a preview affordance from within the first social networking platform application to preview his/her name-card for the first social networking platform. In some embodiments, the name-card may include an identity used for direct presentation to other users, user contact information, a nickname, an avatar, and/or the like. It should be noted that, after the user registers a user account in the first social networking platform, the first social networking platform may generate user contact information according to relevant information provided by the user during registration of the user. For example, the first social networking platform may generate user contact information according to an identity, an avatar, and a nickname that are set during registration by the user, and cache the generated user contact information. Therefore, when the user requests a preview of the user contact information for the first time, the first social networking platform may also directly present a name-card that is locally cached, which reduces the time required by the first social networking platform to acquire the user contact information from a server after the preview request is received, thereby improving user experience.

In some embodiments, in response to the preview request, the client device displays (604) a cached version of the name-card for the user. In some embodiments, in response to the preview request, the client device sends (606) a data acquisition request to the server. For example, the user may have updated the user information since it was originally set during registration by, for example, changing his/her avatar, nickname, and/or the like. Thus, in order to display the latest user information stored by the server, the client device sends a data acquisition request to the server after receiving the preview request for up-to-date user information.

In some embodiments, in response to the data acquisition request, the server identifies (608) up-to-date user information for a user account in the first social networking platform for the user.

In some embodiments, the server provides (610) the up-to-date user information to the client device.

In some embodiments, the client device updates (612) the cached version of the name-card with the received up-to-date user information. In some embodiments, the client device also displays a new version of the name-card based at least in part on the received up-to-date user information.

The client device detects (614) a trigger signal to share in a second social networking platform a name-card for a user with a first user account in the first social networking platform. In some embodiments, the second social networking platform includes a social application client used by a friend (i.e., the recipient) of the user of client device 104 (i.e., the sender). In some embodiments, the name-card includes an identity for direct presentation to the recipient within the second social networking platform application.

After detecting the trigger signal, the client device sends (616) a name-card sharing request the server. In some embodiments, the name-card sharing request is used to request the server to share the name-card for the user's account in the first social networking platform within the second social networking platform.

In response to the name-card sharing request, the server generates (618) a name-card for the user based on user information for the user account in the first social networking platform for the user of the client device.

The server sends (620) the name-card to the second social networking platform. In this case, the name-card includes an identity or contact information of the user of the client device for direct presentation, when the second social networking platform presents the name-card, a second user in the second social networking platform may directly acquire contact information of a friend according to the presented name-card, so as to contact the friend. Therefore, the problems in the prior art with the low utilization efficiency of shared business cards is solved. Furthermore, the effect of directly using data shared by a user is achieved, which improves efficiency and reduces wasting the resources of the server.

It should be understood that the particular order in which the operations in FIG. 6 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods and/or processes described herein (e.g., process 700 and method 800) are also applicable in an analogous manner to process 600 described above with respect to FIG. 6.

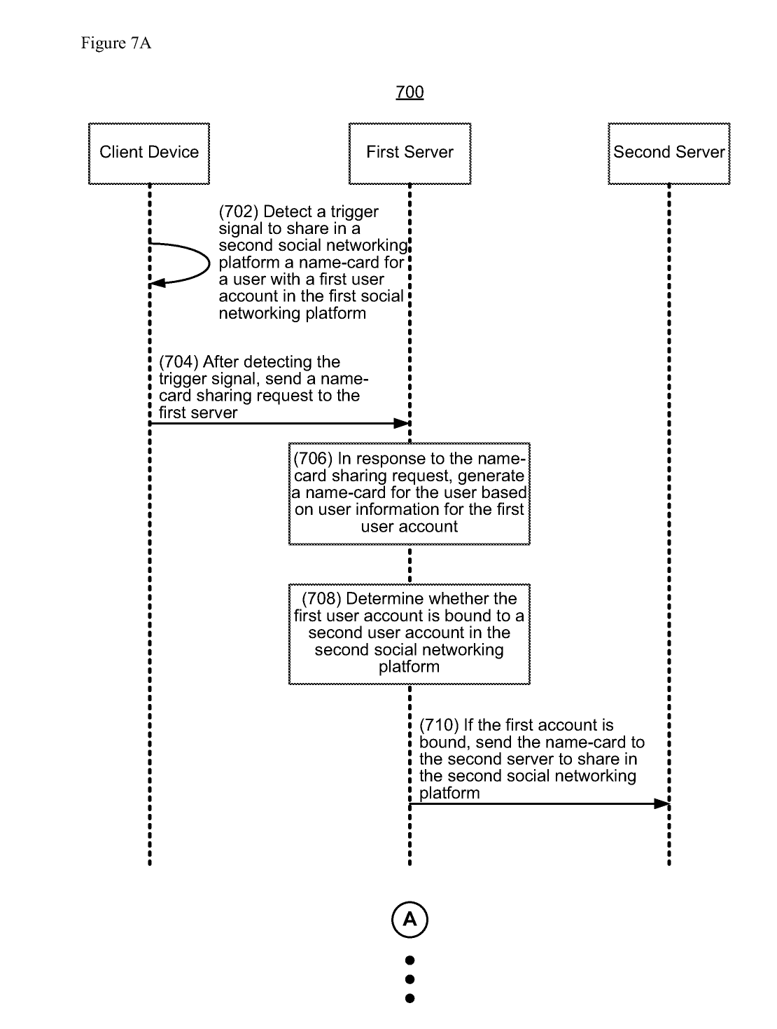

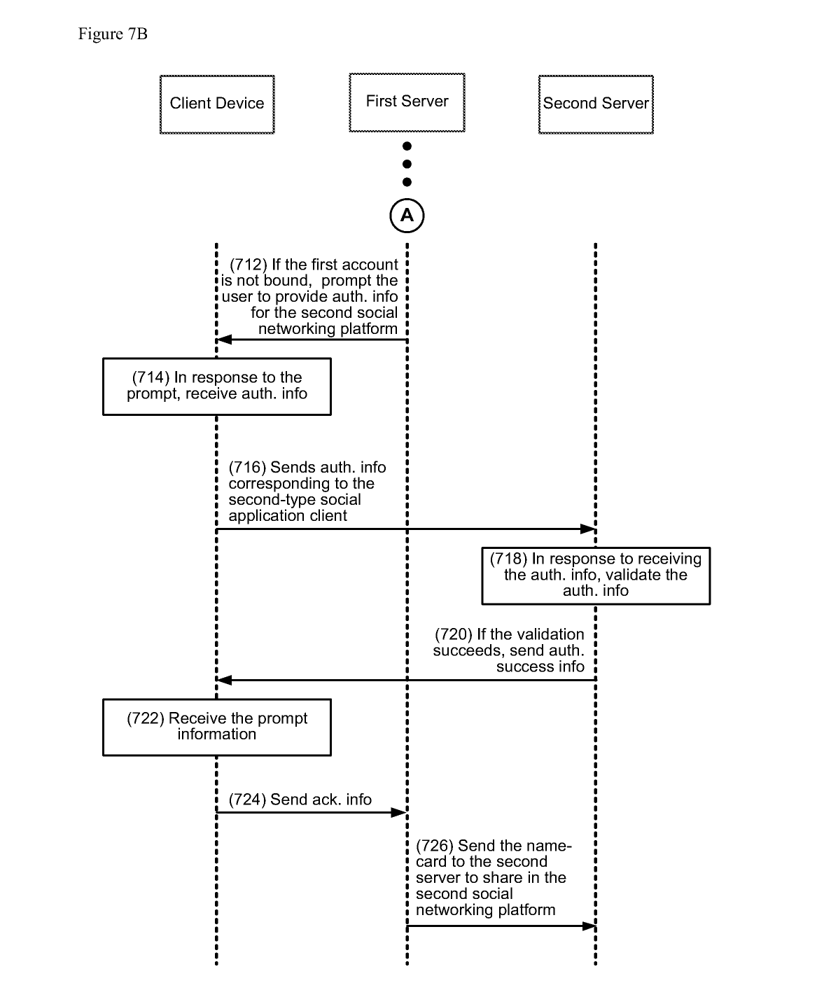

FIGS. 7A-7B illustrates a flow diagram of a process 700 for sharing data between two or more social networking platforms in accordance with some embodiments. In some embodiments, process 700 is performed at least in part by first social networking platform application executed on a client device with one or more processors and memory, a first server with one or more processors and memory that manages and operations the first social networking platform, and a second server with one or more processors and memory that manages and operations a second social networking platform. For example, in some embodiments, process 700 is performed at least in part by a respective client device 104 (FIGS. 1 and 3) or a component thereof (e.g., client-side module A 102, FIGS. 1 and 3), at least in part by server system 108 (FIGS. 1-2) or a component thereof (e.g., server-side module 106, FIG. 2), and at least in part by a respective one of the other social networking platform(s) 122 (FIGS. 1 and 4) or a component thereof (e.g., server-side module 124, FIGS. 1 and 4).

In some embodiments, data processing for a first social networking platform is implemented in client-server environment 100 (FIG. 1) with a server system 108 and client-side module A 102 executed on one or more client devices 104. In some embodiments, server system 108 (FIGS. 1-2) manages and operates the first social networking platform. For example, the first social networking platform is an IM (Instant Messenger) application, an SNS (Social Networking Services) application, or the like, or a combination thereof. In some embodiments, a respective client-side module A 102 (FIGS. 1 and 3) is associated with a user account in the first social networking platform that corresponds to a user of client device 104 (FIGS. 1 and 3).

In some embodiments, data processing for a second social networking platform is implemented in client-server environment 100 (FIG. 1) with a respective one of social networking platform(s) 122 and client-side module B 105 executed on one or more client devices 104. In some embodiments, the respective one of social networking platform(s) 122 (FIGS. 1 and 4) manages and operates the second social networking platform. For example, the second social networking platform is an IM (Instant Messenger) application, an SNS (Social Networking Services) application, or the like, or a combination thereof. In some embodiments, a respective client-side module B 105 (FIGS. 1 and 3) is associated with a user account in the second social networking platform that corresponds to a user of client device 104 (FIGS. 1 and 3).

The client device detects (702) a trigger signal to share in a second social networking platform a name-card for a user with a first user account in the first social networking platform. In some embodiments, the second social networking platform is a social application client used by a friend (i.e., the recipient) of the user of client device 104 (i.e., the sender). In some embodiments, the name-card includes an identity for direct presentation to the recipient within the second social networking platform application. For example, the name-card includes contact information for the user or other user information associated with the first user account of the user in the first social networking platform. In one example, the user of the client device uses two social application clients at the same time (e.g., first social networking platform XX and second social networking platform YY). Continuing with this example, if the user wants to share his/her name-card related to first social networking platform XX to a friend in the second social networking platform YY, the user may select an affordance within an interface of the first social networking platform XX for sharing the name-card trigger signal. Subsequently, the user may also select a recipient and the second social networking platform YY. For example, in FIG. 5A, menu interface 502 of the first social networking platform executed on client device 104-1 includes affordance 504 for sharing the user's name-card with users in other social networking platform.

After detecting the trigger signal, the client device sends (704) a name-card sharing request to the first server. In some embodiments, the name-card sharing request is used to request the first server to share the name-card for the user's account in the first social networking platform within the second social networking platform. In some embodiments, the name-card sharing request includes an indication of the first user account in the first social networking platform of the user of client device 104 (i.e., the sender).

In response to receiving the name-card sharing request, the first server generates (706) a name-card for the user based on user information for the user. After receiving the name-card sharing request, the first server acquires the user information corresponding to the first user account of the user of the client device by searching name-card database 254 (FIG. 2) for user information matching the first user account. In some embodiments, for each user account in the first social networking platform, the first server generates user information including an identity, an avatar, and a nickname of the user based on information received during registration of the first user account and/or information provided during usage of the first user account.

The server determines (708) whether the first user account is bound to a second user account in the second social networking platform. In some embodiments, a user links one or more accounts in other social networking platform to his/her account in the first social networking platform during registration or at a subsequent time by entering login credentials for said one or more accounts. The login credentials for such linked accounts are stored by the first server in linked accounts database 252 (FIG. 2). Specifically, the first server determines whether a second user account in the second social networking platform is bound to the first user account by searching linked accounts database 252 (FIG. 2).

For example, a respective user requests to share his/her name-card for the first social networking platform XX with a friend in second social networking platform YY. Continuing with this example, after receiving the name-card sharing request, the first server corresponding to the first social networking platform XX determines whether the respective user's account in the first social networking platform XX is linked (or bound to) to an account in the second social networking platform YY by searching linked accounts database 252 (FIG. 2).

In accordance with a determination that the first user account is bound to a second user account in the second social networking platform, the first server sends (710) the name-card to the second server to share in the second social networking platform. In some embodiments, the first server sends the name-card to the second server including an indication of the second user account, and, after receiving the name-card, the second server identifies friend relationships between the second user account and users in the second social networking platform. In some embodiments, the second server sends the received name-card to each of the identified users in the second social networking platform with which the first user account has a friend relationship. In some embodiments, to improve resource utilization and to avoid occurrence of a situation in which the name-card is not presented to the identified users, the second server may send the name-card to a respective one of the identified users after receiving an information acquisition from the respective one of the identified users for acquiring news friends.

In some embodiments, the first server shares the name-card to the second server through a predetermined interface or channel. For example, the predetermined interface is an interface for the first server to share picture information to the second server. In some embodiments, after receiving the name-card, the name-card is presented to users in the second social networking platform through the second social networking platform application. For example, the first server shares the name-card to a second server through a predetermined interface and the name-card simultaneously includes an identity, an avatar, and a nickname for the user, the second server sends the name-card to second social networking platform applications executed on client devices of the recipients of the name-card. For example, FIG. 5C shows name-card 524 for Lilizhang displayed within chat interface 522 of the second social networking platform. In FIG. 5C, name-card 524 includes the ID number for the user (i.e., xxxx), the user's name (e.g., Lilizhang) and the user's avatar.

In accordance with a determination that the first user account is not bound to a second user account in the second social networking platform, the first server prompts (712) the user to provide authentication information for the second social networking platform. Specifically, the first server the prompting manner may include an authentication information request page with receiving field(s) used for receiving account information of the second user account for the user in the second social networking platform. FIG. 5B, for example, shows authentication information request interface 512 for entering the user's login credentials for the second social networking platform.

In response to the prompt, the client device receives (714) authentication information for the second user account corresponding to the second social networking platform of the user of the client device. For example, the user of the mobile device enters his/her login name and password for the second user account corresponding to the second social networking platform into the fields in authentication information request interface 512 (FIG. 5B).

The client device sends (716) the received authentication information to the second server corresponding to the second social networking platform. After client device receives the prompt, to ensure the security of an account of the second user account, the client device sends the authentication information to the second server corresponding to the second social networking platform. For example, the authentication information includes a user name and a password of the second user account. In some embodiments, the client device sends the received authentication information to the first server, which forwards the authentication information to the second server for validation.

In response to receiving the authentication information, the second server validates (718) the authentication information sent by the client device. Specifically, in some embodiments, the second server determines whether a user account in the second social networking platform is associated with login credentials matching the authentication information.

In accordance with a determination that the validation succeeds, the second server (720) authentication success information to the client device. In accordance with a determination that the validation fails, the second server, the second server sends authentication failure information to the client device. Subsequently, the client device may request the user to re-enter the authentication information or the client device may request the second server to run the validation again. In some embodiments, the second server authentication success information to the first server.

The client device receives (722) the authentication success information returned by the second server.

The client device sends (724) acknowledgement information to the first server.

After receiving the acknowledgement information, the first server sends (726) the name-card to the second server to share in the second social networking platform as in operation 710.

It should be understood that the particular order in which the operations in FIGS. 7A-7B have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods and/or processes described herein (e.g., process 600 and method 800) are also applicable in an analogous manner to process 700 described above with respect to FIGS. 7A-7B.

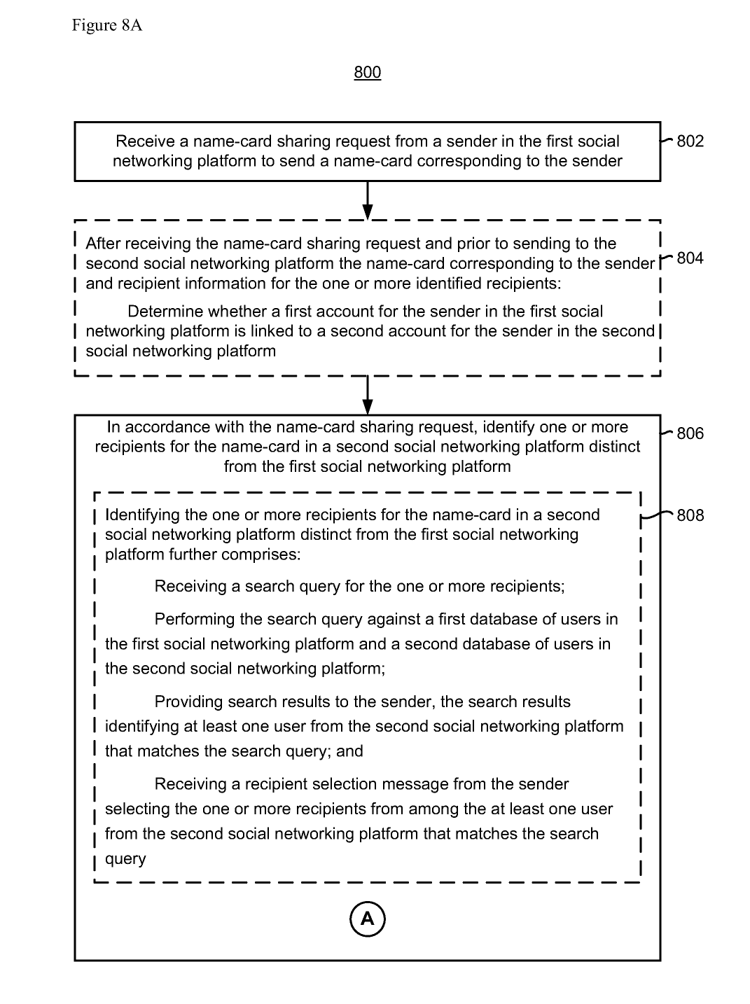

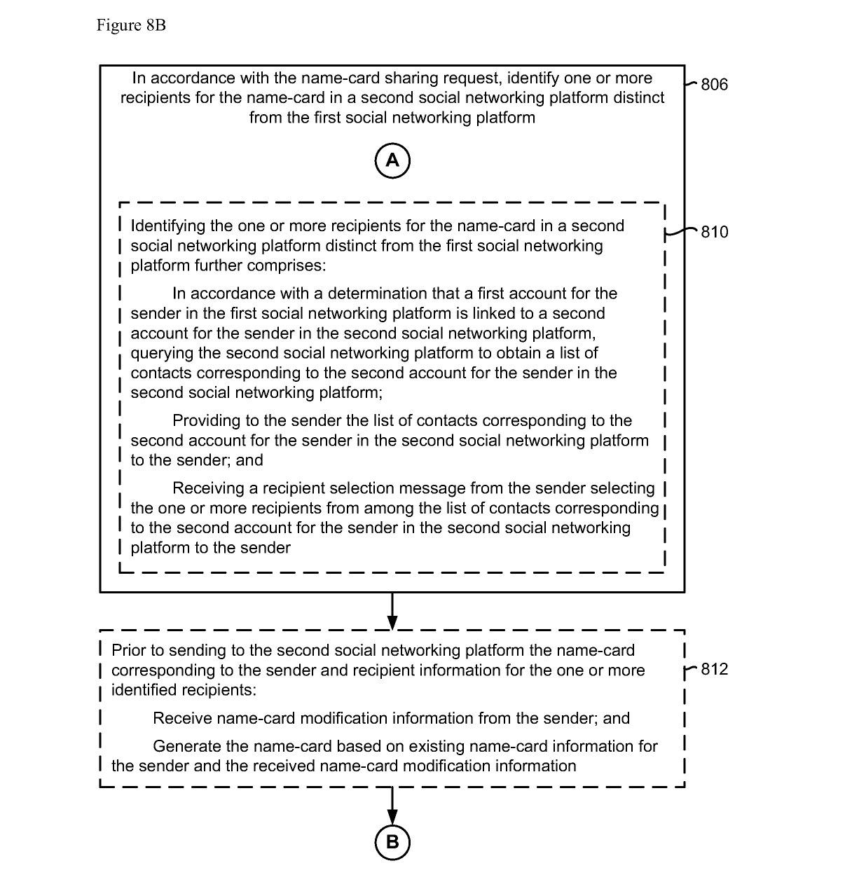

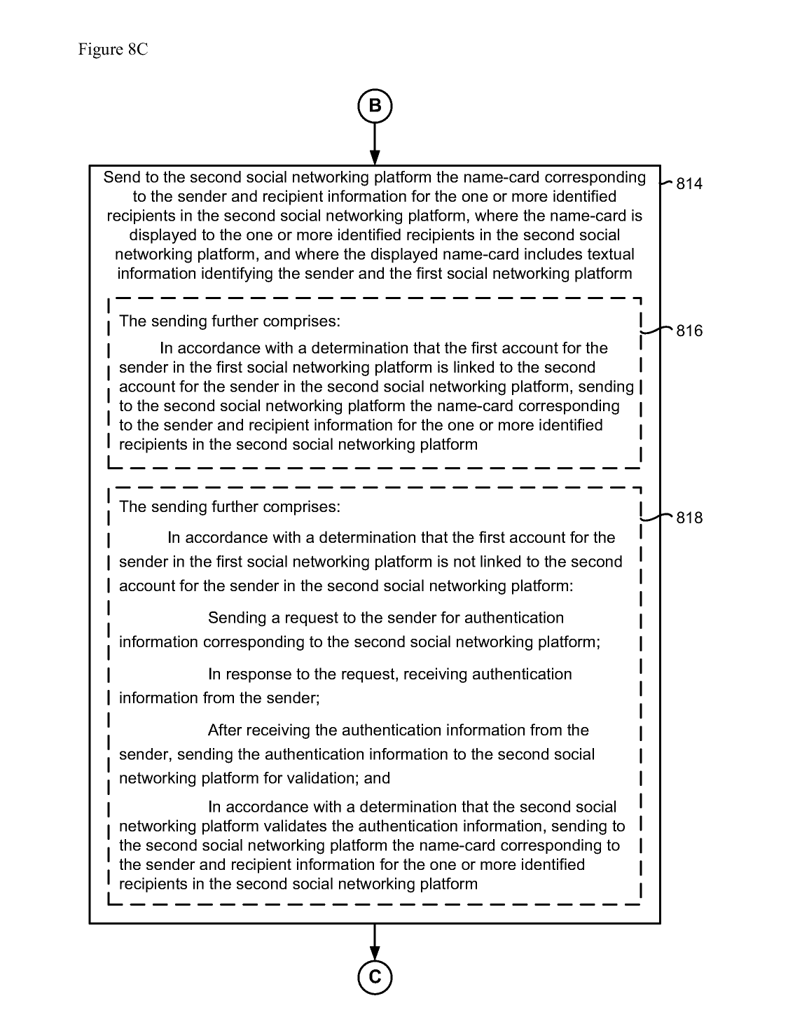

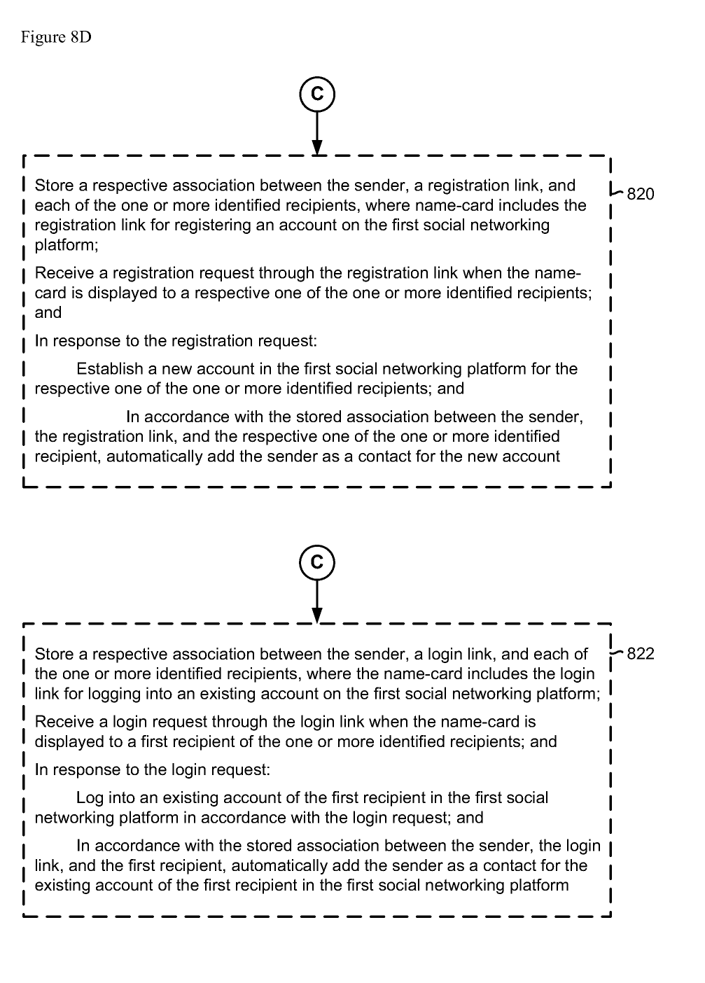

FIGS. 8A-8D illustrate a flowchart diagram of a method 800 of sharing name-cards between social networking platforms in accordance with some embodiments. In some embodiments, method 800 is performed by a server with one or more processors and memory, where the server is associated with a first social networking platform. For example, in some embodiments, method 800 is performed by server system 108 (FIGS. 1-2) or a component thereof (e.g., server-side module 106, FIGS. 1-2). In some embodiments, method 800 is governed by instructions that are stored in a non-transitory computer readable storage medium and the instructions are executed by one or more processors of the server system. Optional operations are indicated by dashed lines (e.g., boxes with dashed-line borders).

In some embodiments, data processing for a first social networking platform is implemented in client-server environment 100 (FIG. 1) with a server system 108 and client-side module A 102 executed on one or more client devices 104. In some embodiments, server system 108 (FIGS. 1-2) manages and operates the first social networking platform. For example, the first social networking platform is an IM (Instant Messenger) application, an SNS (Social Networking Services) application, or the like, or a combination thereof. In some embodiments, a respective client-side module A 102 (FIGS. 1 and 3) is associated with a user account in the first social networking platform that corresponds to a user of client device 104 (FIGS. 1 and 3).

The server receives (802) a name-card sharing request from a sender in the first social networking platform to send a name-card corresponding to the sender. In some embodiments, server system 108 or a component thereof (e.g., request handling module 222, FIG. 2) receives a name-card sharing request from a user (i.e., the sender) of a respective client device 104 that is associated with a first user account in the first social networking platform. In some embodiments, the name-card sharing request indicates one or more other social networking platforms on which the sender wishes to share the name-card and also one or more recipient user accounts in the one or more other social networking platforms. For example, request handling module 222 receives the name-card sharing request from the respective client device 104-1 after the sender (i.e., the user of the respective client device 104-1) selects affordance 504 for sharing the user's name-card with users in other social networking platform in menu interface 502 of the first social networking platform as shown in FIG. 5A.

In some embodiments, the name card is a graphic object that contains identity information and, optionally, contact information for a user, and at least some of the identity information and contact information are textual information plainly viewable (e.g., viewable without using decoding software such as a QR code scanner) by a recipient. The name card can also include other items of information customarily included in a conventional or electronic name-card (i.e., a business card), such as a logo, an avatar, a status, various profile information, and/or the like. In some embodiments, the name-card corresponding to the sender includes generic name card information, such as the real name, title, and contact information of the sender. In some embodiments, the name-card corresponding to the user is platform specific, and includes platform specific information for the sender in lieu of or in addition to other conventional name-card information. For example, the platform specific name-card may include the sender's username, nickname, avatar, tagline, signature, and/or the like. in the social network platform. In some embodiments, the name-card can be static, and the text and graphic information does not change once it is sent. In some embodiments, the name-card can be dynamic, and includes dynamically updated information, such as current online status, current location, current mood, and/or the like, when the name-card is displayed at a recipient's client device. In other words, when the name-card is displayed on a client device, the dynamically updated information presented on the name card changes in real-time when the corresponding status of the user is changed online or in the real world.

In some embodiments, after receiving the name-card sharing request and prior to sending to the second social networking platform the name-card corresponding to the sender and recipient information for the one or more identified recipients, the server determines (804) whether a first account for the sender in the first social networking platform is linked to a second account for the sender in the second social networking platform. In some embodiments, server system 108 or a component thereof (e.g., determining module 224, FIG. 2) determines whether the sender previously linked his/her second account in the second social networking platform to the first account in the first social networking platform. For example, said linking requires entry of the sender's login credentials for the second social networking platform or obtention of a certificate for login into the second social networking platform. In this example, the login credentials or the certificate is encrypted with a key corresponding to the second social networking platform that cannot be decrypted by server system 108. In some embodiments, the user of the first account links the second account in the second social networking platform during registration of the first account or at a time subsequent to registration.

In accordance with the name-card sharing request, the server identifies (806) one or more recipients for the name-card in a second social networking platform distinct from the first social networking platform. In some embodiments, server system 108 or a component thereof (e.g., recipient(s) identification module 228, FIG. 2) identifies one or more recipient in at least one of other social networking platforms 122 based on the respective name-card sharing request. For example, the sender identifies one or more user accounts (e.g., IDs, account handles, or names) in the second social networking platform to be sent the sender's name-card.

In some embodiments, the server identifies the one or more recipients for the name-card in a second social networking platform distinct from the first social networking platform by (808): receiving a search query for the one or more recipients; performing the search query against a first database of users in the first social networking platform and a second database of users in the second social networking platform; providing search results to the sender, the search results identifying at least one user from the second social networking platform that matches the search query; and receiving a recipient selection message from the sender selecting the one or more recipients from among the at least one user from the second social networking platform that matches the search query. In some embodiments, server system 108 or a component thereof (e.g., recipient(s) identification module 228, FIG. 2) receives a search query from the user of the respective client device 104 (i.e., the sender of the name-card). In some embodiments, the search query is a phrase limiting the search against the two databases. For example, the search query is a name or a user characteristic such as and interest, school, occupation, or the like. In some embodiments, server system 108 or a component thereof (e.g., searching module 230, FIG. 2) performs the search query against the first database of users in the first social networking platform and/or the second database of users in the second social networking platform so as to identify a list of potential recipients based on the received search query. In some embodiments, the server of the first social networking platform performs the query against its own database of users, and sends the query to a server of the second social networking platform to obtain the search result on the second social networking platform. In some embodiments, the server of the social networking platform performs the search against its own database of users, and performs a search on a search engine and processes the search result to identify users on other social networking platforms that match the search query. Subsequently, in some embodiments, server system 108 or a component thereof (e.g., providing module 234, FIG. 2) provides the search results to the user of the respective client device 104 as a list of potential recipients. In some embodiments, server system 108 or a component thereof (e.g., selection reception module 236, FIG. 2) receives a recipient selection message from the user of the respective client device 104 selecting one or more recipients from the list of potential recipients sent by providing module 234.

In some embodiments, the server identifies the one or more recipients for the name-card in a second social networking platform distinct from the first social networking platform by (810): in accordance with a determination that a first account for the sender in the first social networking platform is linked to a second account for the sender in the second social networking platform, querying the second social networking platform to obtain a list of contacts corresponding to the second account for the sender in the second social networking platform; providing to the sender the list of contacts corresponding to the second account for the sender in the second social networking platform to the sender; and receiving a recipient selection message from the sender selecting the one or more recipients from among the list of contacts corresponding to the second account for the sender in the second social networking platform to the sender. In some embodiments, after server system 108 or a component thereof (e.g., determining module 224, FIG. 2) determines that the first user account is linked to a second account for the sender in the second social networking platform, server system 108 or a component thereof (e.g., querying module 232, FIG. 2) queries the second social networking platform for a list of contacts for the second user account in the second social networking platform. Subsequently, in some embodiments, server system 108 or a component thereof (e.g., providing module 234, FIG. 2) provides the list of contacts to the user of the respective client device 104 as a list of potential recipients. In some embodiments, server system 108 or a component thereof (e.g., selection reception module 236, FIG. 2) receives a recipient selection message from the user of the respective client device 104 selecting one or more recipients from list of contacts sent by providing module 234. In some embodiments, the list of contact is a complete list of contacts for the sender on the second social networking platform. In some embodiments, the user has provided one or more filtering criteria (e.g., in a search query), and the list of contacts are contacts that meet the specified filtering criteria. In some embodiments, the sender has a second account in the second social networking platform that is linked to the sender's first account in the first social networking platform and the social networking platforms have a communication channel for sending and receiving contacts lists for authentic users.

In some embodiments, prior to sending to the second social networking platform the name-card corresponding to the sender and recipient information for the one or more identified recipients, the server (812): receives name-card modification information from the sender; and generates the name-card based on existing name-card information for the sender and the received name-card modification information. For example, the sender previews a version of the name-card that is cached by the respective client device 104 and, subsequently, requests an up-to-date version of the name-card from server system 108. In turn, continuing with this example, the respective client device 104 displays an up-to-date version of the name-card, and, subsequently, the sender modifies the up-to-date version of the name-card and sends the modification information to server system 108. In fact, in this example, when the sender selects to preview the name-card, the respective client device 104 loads a cached version of the name-card to display to the sender immediately, and at the same time, the respective client device 104 sends a request to retrieve a most-up-to-date version of the name-card from server system 108. When the most-up-to-date version is received from server system 108, the respective client device 104 updates the display to show the most-up-to-date version of the name-card. This improves user experience, because it makes the loading time less annoying to the user. After the user modifies the most-up-to-date version of the name-card saved at the server and shares the modified name-card with others, the shared name-card is cached locally and saved at the serve as the most-up-to-date version of the name-card.

The server sends (814) to the second social networking platform the name-card corresponding to the sender and recipient information for the one or more identified recipients in the second social networking platform, where the name-card is displayed to the one or more identified recipients in the second social networking platform, and where the displayed name-card includes textual information identifying the sender and the first social networking platform. In some embodiments, server system 108 or a component thereof (e.g., sending module 240, FIG. 2) sends the name-card to a respective one of the other social networking platforms 122 to share in the second social networking platform with the user accounts in the second social networking platform that correspond to the one or more identified recipients. FIG. 5C, for example, shows respective client device 104-2 of one of the recipients displaying name-card 524 within chat interface 522 of the second social networking platform (e.g., an instant messaging application).

In some embodiments, the name-card includes un-encoded information such as an ID associated with the sender's profile in the first social networking platform, an avatar for the sender in the first social networking platform, a handle for the sender in the first social networking platform, and/or the like. In FIG. 5C, for example, name-card 524 for Lilizhang includes the ID number for Lilizhang's account in the first social networking platform (i.e., xxxx) and Lilizhang's avatar in the first social networking platform. In some embodiments, the name-card sharing request includes the name-card. In some embodiments, the name-card is dynamically generated after receiving the name-card sharing request based on up-to-date information corresponding to the sender and the sender's profile in the first social networking platform.

In some embodiments, the sender does not have an account in the second social networking platform and the recipient does not have an account in the first social networking platform. In some embodiments, server system 108 of the first social networking platform sends the name-card and the recipient information to the respective one of the other social networking platforms 122 (i.e., the provider of the second social networking platform), and the respective one of the other social networking platforms 122 sends the name-card to the identified recipients on behalf of the sender in the second social networking platform. For example, if the sender does not already have an account on the second social network platform, the respective one of the other social networking platforms 122 can prepare a message including the name card, and send the message from a public account associated with the respective one of the other social networking platforms 12. For example, the respective one of the other social networking platforms 122 can have a dedicated public account for sending name-cards received from other social network accounts. This can be implemented to promote cross-promotion, and fair competition. Also, in some cases, the same entity may control multiple social network platforms, and can implement this to cross-promote their social networking platforms.

In some embodiments, the server sends (816) to the second social networking platform the name-card corresponding to the sender and recipient information for the one or more identified recipients in the second social networking platform in accordance with a determination that the first account for the sender in the first social networking platform is linked to the second account for the sender in the second social networking platform. In some embodiments, server system 108 or a component thereof (e.g., sending module 240, FIG. 2) sends the name-card to a respective one of the other social networking platforms 122 to share in the second social networking platform with the user accounts in the second social networking platform that correspond to the one or more identified recipients after server system 108 or a component thereof (e.g., determining module 224, FIG. 2) determines that the sender's first user account in the first social networking platform is linked to a second user account in the second social networking platform.

In some embodiments, in accordance with a determination that the first account for the sender in the first social networking platform is not linked to the second account for the sender in the second social networking platform, the server (818): sends a request to the sender for authentication information corresponding to the second social networking platform; in response to the request, receiving authentication information from the sender; after receiving the authentication information from the sender, sending the authentication information to the second social networking platform for validation; and, in accordance with a determination that the second social networking platform validates the authentication information, sending to the second social networking platform the name-card corresponding to the sender and recipient information for the one or more identified recipients in the second social networking platform. In some embodiments, after server system 108 or a component thereof (e.g., determining module 224, FIG. 2) determines that the sender's first user account in the first social networking platform is not linked to a second user account in the second social networking platform, server system 108 or a component thereof (e.g., prompting module 226, FIG. 2) prompts the sender to provide authentication information for the second social networking platform. FIG. 5B, for example, shows respective client device 104-1 of the sender displaying authentication information request interface 512 of the first social networking platform. In FIG. 5B, authentication information request interface 512 prompts the sender enter his/her login credentials for the second social networking platform into the user name and password fields.

Subsequently, in some embodiments, server system 108 receives authentication information from the sender for the second social networking platform and sends the received authentication information to a respective one of the other social networking platforms 122 that provides the second social networking platform. For example, the authentication information includes login credentials for the second social networking platform. In some embodiments, in response to sending the authentication information to the respective one of the other social networking platforms 122, server system 108 receives a message from the respective one of the other social networking platforms 122 indicating whether the authentication information for the second social networking platform is valid. In some embodiments, in accordance with a determination that the authentication information is valid, server system 108 or a component thereof (e.g., sending module 240, FIG. 2) sends the name-card to a respective one of the other social networking platforms 122 to share in the second social networking platform with the user accounts in the second social networking platform that correspond to the one or more identified recipients. In some embodiments, in accordance with a determination that the authentication information is not valid, the sender is prompted to try again or a previous interface of the first social networking platform is displayed.

In some embodiments, the name-card includes a registration link for registering an account on the first social networking platform, and the server (820): stores a respective association between the sender, the registration link, and each of the one or more identified recipients; receives a registration request through the registration link when the name-card is displayed to a respective one of the one or more identified recipients; and, in response to the registration request: establishes a new account in the first social networking platform for the respective one of the one or more identified recipients; and, in accordance with the stored association between the sender, the registration link, and the respective one of the one or more identified recipient, automatically adds the sender as a contact for the new account. In some embodiments, the name-card sent by server system 108 or a component thereof (e.g., sending module 240, FIG. 2) includes a registration link for registering a new user account in the first social networking platform. In some embodiments, server system 108 or a component thereof (e.g., responding module 242, FIG. 2) establishes a new account in the first social networking platform for a respective one of the one or more identified recipients and adds the sender as a contact for the new user account of the respective one of the one or more identified recipients in response to a registration request from the respective one of the one or more identified recipients associated with the registration link in the name-card displayed to the respective one of the one or more identified recipients associated.

In some embodiments, the name-card includes a login link for logging into an existing account on the first social networking platform, and the server (822): stores a respective association between the sender, the login link, and each of the one or more identified recipients; receives a login request through the login link when the name-card is displayed to a first recipient of the one or more identified recipients; and, in response to the login request: logs into an existing account of the first recipient in the first social networking platform in accordance with the login request; and, in accordance with the stored association between the sender, the login link, and the first recipient, automatically adds the sender as a contact for the existing account of the first recipient in the first social networking platform. In some embodiments, the name-card sent by server system 108 or a component thereof (e.g., sending module 240, FIG. 2) includes a login link for logging into an existing user account in the first social networking platform. In some embodiments, server system 108 or a component thereof (e.g., responding module 242, FIG. 2) logs into an existing user account for a respective one of the one or more identified recipients and adds the sender as a contact for the existing user account of the respective one of the one or more identified recipients in response to a login request from the respective one of the one or more identified recipients associated with the login link in the name-card displayed to the respective one of the one or more identified recipients associated.

It should be understood that the particular order in which the operations in FIGS. 8A-8D have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods and/or processes described herein (e.g., processes 600 and 700) are also applicable in an analogous manner to method 800 described above with respect to FIGS. 8A-8D.

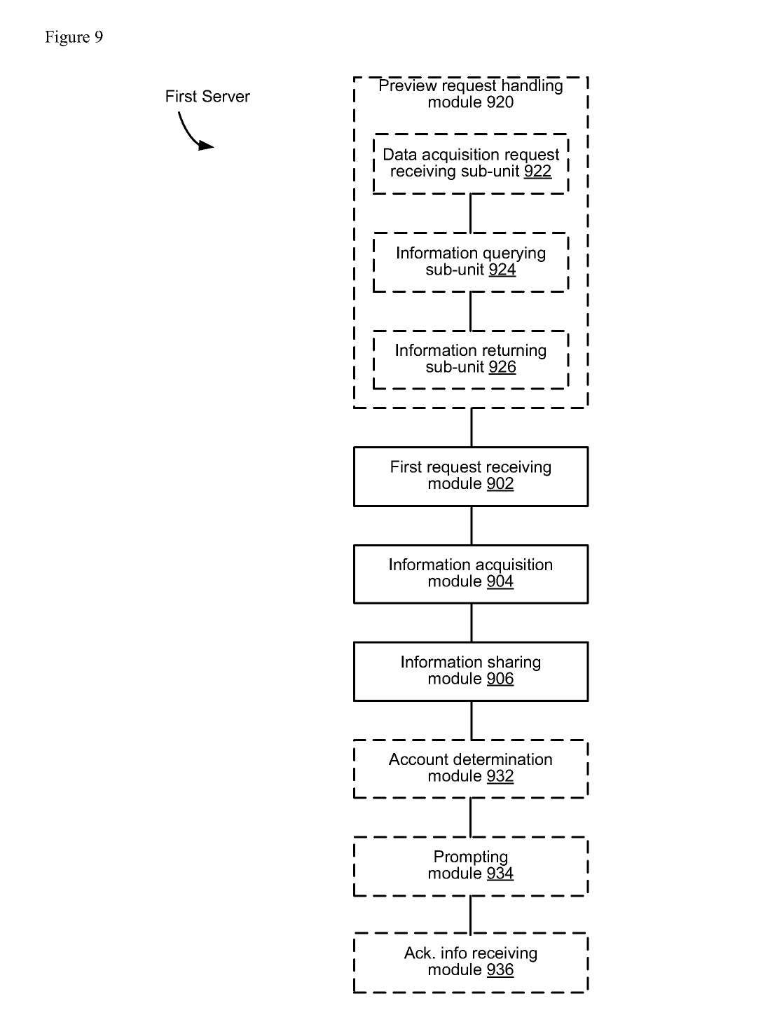

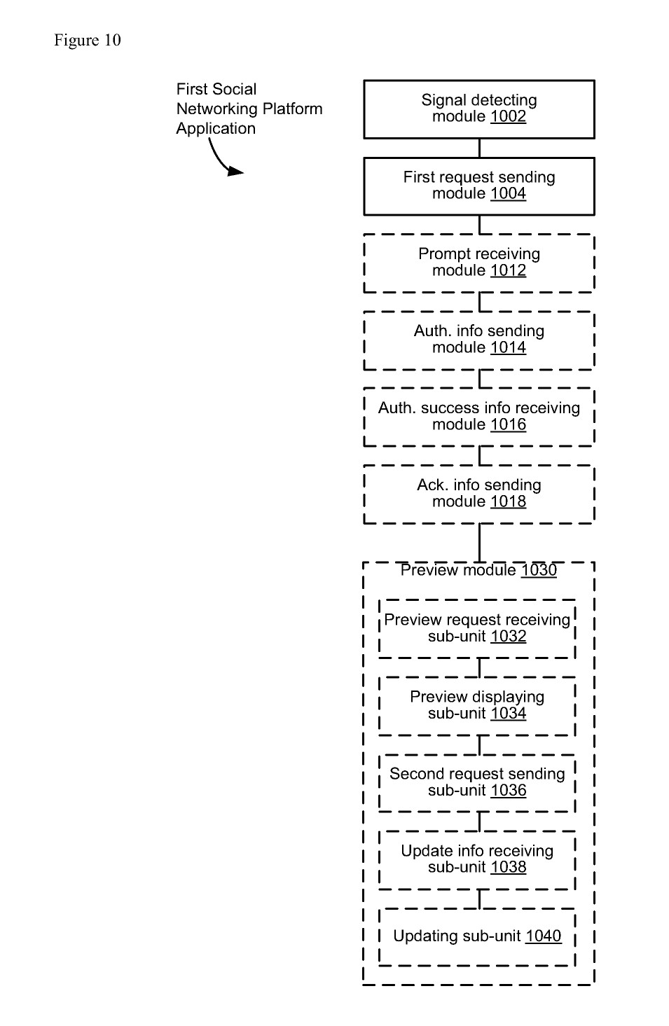

FIG. 9 is a block diagram of a first server 900 for sharing data in accordance with some embodiments. In some embodiments, first server 900 manages and operates a first social networking platform. For example, first server 900 corresponds to server system 108 (FIGS. 1-2) or a component thereof (e.g., server-side module 106, FIGS. 1-2). In some embodiments, first server 900 includes: a first request receiving module 902, an information acquisition module 904, and an information sharing module 906. In some embodiments, data processing for the first social networking platform includes a server-side portion (e.g., first server 900, FIG. 9) and a client-side portion (e.g., first social networking platform application 1000, FIG. 10) executed on a client device 104.

In some embodiments, first request receiving module 902 is configured to receive a name-card sharing request from a respective client device 104 to share a name-card in a second social networking platform, where the name-card sharing request corresponds to a first user account in the first social networking platform.

In some embodiments, information acquisition module 904 is configured to acquire user information corresponding to the first user account and generate the name-card for the first user account based at least in part on the acquired user information.

In some embodiments, information sharing module 906 is configured to send the generated name-card to a second server (e.g., a respective one of other social networking platforms 122, FIGS. 1 and 4) to share in the second social networking platform. In some embodiments, the second server manages and operations the second social networking platform.

In some embodiments, first server 900 also includes a preview request handling module 920 configured to handle preview requests from client devices 104. In some embodiments, preview request handling module 920 includes: a data acquisition request receiving sub-unit 922, an information querying sub-unit 924, and an information returning sub-unit 926.

In some embodiments, data acquisition request receiving sub-unit 922 is configured to receive a data acquisition request from a respective client device 104, where the data acquisition request corresponds to a first user account in the first social networking platform.

In some embodiments, information querying sub-unit 924 is configured to identify up-to-date user information for the first user account.

In some embodiments, information returning sub-unit 926 is configured to provide the up-to-date user information for the first user account to the respective client device 104.

In some embodiments, first server 900 further includes: an account determination module 932, a prompting module 934, and an acknowledgment information receiving module 936.

In some embodiments, account determination module 932 is configured to determine whether the first user account related to the name-card sharing request is bound to a second user account in the second social networking platform.

In some embodiments, prompting module 934 is configured to prompt the user of the respective client device 104 to provide authentication information for the second social networking platform in accordance with a determination that the first user account in the first social networking platform is not linked to a second user account in the second social networking platform.

In some embodiments, acknowledgment information receiving module 936 is configured to receive acknowledgment information from the respective client device 104 in accordance with a determination that the authentication information entered by the user of the respective client device 104 for the second social networking platform has been validated by the second server.

FIG. 10 is a block diagram of a first social networking platform application 1000 for sharing data in accordance with some embodiments. In some embodiments, first social networking platform application 1000 is a client-side portion of the first social networking platform that is executed on a respective client device. For example, first social networking platform application 1000 (e.g., client-side module A 102, FIGS. 1 and 3) is executed on a client device 104 (FIGS. 1 and 3). In some embodiments, first social networking platform application 1000 includes: a signal detecting module 1002 and a first request sending module 1004. In some embodiments, data processing for the first social networking platform includes a server-side portion (e.g., first server 900, FIG. 9) and a client-side portion (e.g., first social networking platform application 1000, FIG. 10) executed on a client device 104.

In some embodiments, signal detecting module 1002 is configured to detect a trigger signal from a user of the respective client device 104 initiating a name-card sharing function of the first social networking platform application 1000.

In some embodiments, first request sending module 1004 is configured to send a name-card sharing request to first server 900 (FIG. 9) after signal detecting module 1002 detects the trigger signal for a name-card sharing function.

In some embodiments, first social networking platform application 1000 also includes: a prompt receiving module 1012, an authentication information sending module 1014, an authentication success information receiving module 1016, and an acknowledgment information sending module 1018.

In some embodiments, prompt receiving module 1012 is configured to receive a prompt from first server 900 for providing authentication information for the second social networking platform.

In some embodiments, authentication information sending module 1014 is configured to sending authentication information for a second user account in the second social networking platform to the second server (e.g., a respective one of other social networking platforms 122, FIGS. 1 and 4).

In some embodiments, authentication success information receiving module 1016 is configured to receive authentication success information from the second server after the second server validates the authentication information sent by authentication information sending module 1014.

In some embodiments, acknowledgment information sending module 1018 is configured to send acknowledgment information to first server 900 indicating validation of the authentication information by the second server.

In some embodiments, first server 900 further includes a preview module 1030 configured to present a preview of the name-card to the user of client device 104. In some embodiments, preview module 1030 includes: a preview request receiving sub-unit 1032, a preview displaying sub-unit 1034, a second request sending sub-unit 1036, an update information receiving sub-unit 1038, and an updating sub-unit 1040.

In some embodiments, preview request receiving sub-unit 1032 is configured to detect a preview request from the user of the respective client device 104 initiating a name-card preview function of the first social networking platform application 1000.

In some embodiments, preview displaying sub-unit 1034 is configured to displaying a cached version of the name-card for the user of the respective client device 104 after preview request receiving sub-unit 1032 detects the preview request.

In some embodiments, second request sending sub-unit 1036 is configured to send a data acquisition request to first server 900 after preview request receiving sub-unit 1032 detects the preview request.

In some embodiments, update information receiving sub-unit 1038 is configured to receive up-to-date user information for the user of the respective client device 104 from first server 900.

In some embodiments, updating sub-unit 1040 is configured to update the cached version of the name-card for the user of the respective client device 104 based at least in part on the received up-to-date user information.

While particular embodiments are described above, it will be understood it is not intended to limit the application to these particular embodiments. On the contrary, the application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

What is claimed is:

1. A method of sharing name-cards between social networking platforms, comprising:
at a server with one or more processors and memory, wherein the server is associated with a first social networking platform:
receiving a name-card sharing request from a sender in the first social networking platform to send a name-card corresponding to the sender;
in accordance with the name-card sharing request, identifying one or more recipients for the name-card in a second social networking platform distinct from the first social networking platform; and
sending to the second social networking platform the name-card corresponding to the sender and recipient information for the one or more identified recipients in the second social networking platform, wherein the name-card is displayed to the one or more identified recipients in the second social networking platform, and wherein the displayed name-card includes textual information identifying the sender and the first social networking platform.

2. The method of claim 1, further comprising:
prior to sending to the second social networking platform the name-card corresponding to the sender and recipient information for the one or more identified recipients:
receiving name-card modification information from the sender; and
generating the name-card based on existing name-card information for the sender and the received name-card modification information.

3. The method of claim 1, wherein identifying the one or more recipients for the name-card in a second social networking platform distinct from the first social networking platform further comprises:
receiving a search query for the one or more recipients;
performing the search query against a first database of users in the first social networking platform and a second database of users in the second social networking platform;
providing search results to the sender, the search results identifying at least one user from the second social networking platform that matches the search query; and
receiving a recipient selection message from the sender selecting the one or more recipients from among the at least one user from the second social networking platform that matches the search query.

4. The method of claim 1, further comprising:
after receiving the name-card sharing request and prior to sending to the second social networking platform the name-card corresponding to the sender and recipient information for the one or more identified recipients:
determining whether a first account for the sender in the first social networking platform is linked to a second account for the sender in the second social networking platform.

5. The method of claim 4, wherein identifying the one or more recipients for the name-card in a second social networking platform distinct from the first social networking platform further comprises:
in accordance with a determination that a first account for the sender in the first social networking platform is linked to a second account for the sender in the second social networking platform, querying the second social networking platform to obtain a list of contacts corresponding to the second account for the sender in the second social networking platform;
providing to the sender the list of contacts corresponding to the second account for the sender in the second social networking platform to the sender; and
receiving a recipient selection message from the sender selecting the one or more recipients from among the list of contacts corresponding to the second account for the sender in the second social networking platform to the sender.

6. The method of claim 4, wherein sending to the second social networking platform the name-card corresponding to the sender and recipient information for the one or more identified recipients in the second social networking platform further comprises:
in accordance with a determination that the first account for the sender in the first social networking platform is linked to the second account for the sender in the second social networking platform, sending to the second social networking platform the name-card corresponding to the sender and recipient information for the one or more identified recipients in the second social networking platform.

7. The method of claim 4, wherein sending to the second social networking platform the name-card corresponding to the sender and recipient information for the one or more identified recipients in the second social networking platform further comprises:
in accordance with a determination that the first account for the sender in the first social networking platform is not linked to the second account for the sender in the second social networking platform:
sending a request to the sender for authentication information corresponding to the second social networking platform;
in response to the request, receiving authentication information from the sender;
after receiving the authentication information from the sender, sending the authentication information to the second social networking platform for validation; and
in accordance with a determination that the second social networking platform validates the authentication information, sending to the second social networking platform the name-card corresponding to the sender and recipient information for the one or more identified recipients in the second social networking platform.

8. A server, comprising:
one or more processors; and
memory storing one or more programs to be executed by the one or more processors, the one or more programs comprising instructions for:
receiving a name-card sharing request from a sender in a first social networking platform provided by the server to send a name-card corresponding to the sender;
in accordance with the name-card sharing request, identifying one or more recipients for the name-card in a second social networking platform distinct from the first social networking platform; and
sending to the second social networking platform the name-card corresponding to the sender and recipient information for the one or more identified recipients in the second social networking platform, wherein the name-card is displayed to the one or more identified recipients in the second social networking platform, and wherein the displayed name-card includes textual information identifying the sender and the first social networking platform.

9. The server of claim 8, wherein the one or more programs further comprise instructions for:
prior to sending to the second social networking platform the name-card corresponding to the sender and recipient information for the one or more identified recipients:
receiving name-card modification information from the sender; and
generating the name-card based on existing name-card information for the sender and the received name-card modification information.

10. The server of claim 8, wherein identifying the one or more recipients for the name-card in a second social networking platform distinct from the first social networking platform further comprises:
receiving a search query for the one or more recipients;
performing the search query against a first database of users in the first social networking platform and a second database of users in the second social networking platform;
providing search results to the sender, the search results identifying at least one user from the second social networking platform that matches the search query; and
receiving a recipient selection message from the sender selecting the one or more recipients from among the at least one user from the second social networking platform that matches the search query.

11. The server of claim 8, wherein the one or more programs further comprise instructions for:
after receiving the name-card sharing request and prior to sending to the second social networking platform the name-card corresponding to the sender and recipient information for the one or more identified recipients:
determining whether a first account for the sender in the first social networking platform is linked to a second account for the sender in the second social networking platform.

12. The server of claim 11, wherein identifying the one or more recipients for the name-card in a second social networking platform distinct from the first social networking platform further comprises:
in accordance with a determination that a first account for the sender in the first social networking platform is linked to a second account for the sender in the second social networking platform, querying the second social networking platform to obtain a list of contacts corresponding to the second account for the sender in the second social networking platform;
providing to the sender the list of contacts corresponding to the second account for the sender in the second social networking platform to the sender; and
receiving a recipient selection message from the sender selecting the one or more recipients from among the list of contacts corresponding to the second account for the sender in the second social networking platform to the sender.

13. The server of claim 11, wherein sending to the second social networking platform the name-card corresponding to the sender and recipient information for the one or more identified recipients in the second social networking platform further comprises:
in accordance with a determination that the first account for the sender in the first social networking platform is linked to the second account for the sender in the second social networking platform, sending to the second social networking platform the name-card corresponding to the sender and recipient information for the one or more identified recipients in the second social networking platform.

14. The server of claim 11, wherein sending to the second social networking platform the name-card corresponding to the sender and recipient information for the one or more identified recipients in the second social networking platform further comprises:
in accordance with a determination that the first account for the sender in the first social networking platform is not linked to the second account for the sender in the second social networking platform:
sending a request to the sender for authentication information corresponding to the second social networking platform;
in response to the request, receiving authentication information from the sender;
after receiving the authentication information from the sender, sending the authentication information to the second social networking platform for validation; and
in accordance with a determination that the second social networking platform validates the authentication information, sending to the second social networking platform the name-card corresponding to the sender and recipient information for the one or more identified recipients in the second social networking platform.

15. A non-transitory computer readable storage medium storing one or more programs, the one or more programs comprising instructions, which, when executed by a server with one or more processors, cause the server to perform operations comprising:
receiving a name-card sharing request from a sender in a first social networking platform provided by the server to send a name-card corresponding to the sender;
in accordance with the name-card sharing request, identifying one or more recipients for the name-card in a second social networking platform distinct from the first social networking platform; and
sending to the second social networking platform the name-card corresponding to the sender and recipient information for the one or more identified recipients in the second social networking platform, wherein the name-card is displayed to the one or more identified recipients in the second social networking platform, and wherein the displayed name-card includes textual information identifying the sender and the first social networking platform.

16. The non-transitory computer readable storage medium of claim 15, wherein identifying the one or more recipients for the name-card in a second social networking platform distinct from the first social networking platform further comprises:
receiving a search query for the one or more recipients;
performing the search query against a first database of users in the first social networking platform and a second database of users in the second social networking platform;
providing search results to the sender, the search results identifying at least one user from the second social networking platform that matches the search query; and
receiving a recipient selection message from the sender selecting the one or more recipients from among the at least one user from the second social networking platform that matches the search query.

17. The non-transitory computer readable storage medium of claim 15, wherein the instructions cause the server to perform operations further comprising:
after receiving the name-card sharing request and prior to sending to the second social networking platform the name-card corresponding to the sender and recipient information for the one or more identified recipients:
determining whether a first account for the sender in the first social networking platform is linked to a second account for the sender in the second social networking platform.

18. The non-transitory computer readable storage medium of claim 17, wherein identifying the one or more recipients for the name-card in a second social networking platform distinct from the first social networking platform further comprises:
in accordance with a determination that a first account for the sender in the first social networking platform is linked to a second account for the sender in the second social networking platform, querying the second social networking platform to obtain a list of contacts corresponding to the second account for the sender in the second social networking platform;
providing to the sender the list of contacts corresponding to the second account for the sender in the second social networking platform to the sender; and
receiving a recipient selection message from the sender selecting the one or more recipients from among the list of contacts corresponding to the second account for the sender in the second social networking platform to the sender.

19. The non-transitory computer readable storage medium of claim 17, wherein sending to the second social networking platform the name-card corresponding to the sender and recipient information for the one or more identified recipients in the second social networking platform further comprises:
in accordance with a determination that the first account for the sender in the first social networking platform is linked to the second account for the sender in the second social networking platform, sending to the second social networking platform the name-card corresponding to the sender and recipient information for the one or more identified recipients in the second social networking platform.

20. The non-transitory computer readable storage medium of claim 17, wherein sending to the second social networking platform the name-card corresponding to the sender and recipient information for the one or more identified recipients in the second social networking platform further comprises:
in accordance with a determination that the first account for the sender in the first social networking platform is not linked to the second account for the sender in the second social networking platform:
sending a request to the sender for authentication information corresponding to the second social networking platform;
in response to the request, receiving authentication information from the sender;
after receiving the authentication information from the sender, sending the authentication information to the second social networking platform for validation; and
in accordance with a determination that the second social networking platform validates the authentication information, sending to the second social networking platform the name-card corresponding to the sender and recipient information for the one or more identified recipients in the second social networking platform.
